(19) United States
(12) Patent Application Publication
(10) Pub. No.: US 2026/0219842 A1
(43) Pub. Date: Jul. 30, 2026

(54) METHOD, APPARATUS, DEVICE, MEDIUM, AND PROGRAM PRODUCT FOR ORCHESTRATING COMPONENTS

(71) Applicants: Lemon Inc., Grand Cayman (KY); Beijing Zitiao Network Technology Co., Ltd., Beijing (CN)

(72) Inventors: Huaqing LUO, Singapore (SG); Dezheng WANG, Beijing (CN); Pandeng LI, Beijing (CN); Tong SHEN, Beijing (CN); Zhaonan XU, Beijing (CN)

(21) Appl. No.: 19/369,052

(22) Filed: Oct. 24, 2025

(30) Foreign Application Priority Data
Dec. 13, 2024 (CN) 202411844653.8

(51) Int. Cl. G06F 8/20

(52) U.S. Cl. CPC G06F 8/20

(57) ABSTRACT

Embodiments of the present disclosure provide a method, an apparatus, a device, a storage medium and a computer program product for orchestrating components. The method includes determining at least one defined interaction mode of a target component according to a type of a parameter of the target component. The method further includes generating an interaction mode set of the target component based on the at least one defined interaction mode, the interaction mode set supporting a plurality of combinations of streaming input, non-streaming input, streaming output and non-streaming output. The method further includes selecting a target interaction mode of the target component from the interaction mode set based on an operating environment of the target component, to orchestrate the target component.

### CROSS-REFERENCE TO RELATED APPLICATION(S

This application claims priority to Chinese Application No. 202411844653.8 filed December. 13, 2024, the disclosure of which is incorporated herein by reference in its entirety.

### FIELD

The present disclosure generally relates to the field of computers, and more particularly, to a method, an apparatus, a device, a computer-readable storage medium and a computer program product for orchestrating components.

### BACKGROUND

An application development framework is a framework designed to simplify and speed up the process of creating applications. Such a framework typically incorporates various functions, enabling developers to focus on building intelligent logic and business rules, rather than implementing infrastructure from scratch. The application development framework provides a graph structure formed from the perspective of component orchestration for developing applications. The application development framework may be, for example, an artificial intelligence application development framework.

The artificial intelligence application development framework supports organizing these components in a graph. This means that users can build the workflow of the entire application by defining nodes (representing individual components) and edges (representing dependencies or data flow between components). Such graphical orchestration capabilities allow developers to understand and design complex application architectures more intuitively, while also facilitating debugging and optimization.

### SUMMARY

According to example embodiments of the present disclosure, a method, an apparatus, a device, a computer storage medium and a computer program product for orchestrating components are provided.

In a first aspect of the present disclosure, a method for orchestrating components is provided, the method includes determining at least one defined interaction mode of a target component according to a type of a parameter of the target component. The method further includes generating an interaction mode set of the target component based on the at least one defined interaction mode, the interaction mode set supporting a plurality of combinations of streaming input, non-streaming input, streaming output and non-streaming output. The method further includes selecting a target interaction mode of the target component from the interaction mode set based on an operating environment of the target component, to orchestrate the target component.

In a second aspect of the present disclosure, an apparatus for orchestrating components is provided, the apparatus includes a determination module configured to determine at least one defined interaction mode of a target component according to a type of a parameter of the target component. The apparatus further includes a generation module configured to generate an interaction mode set of the target component based on the at least one defined interaction mode, the interaction mode set supporting a plurality of combinations of streaming input, non-streaming input, streaming output and non-streaming output. The apparatus further includes a selection module configured to select a target interaction mode of the target component from the interaction mode set based on an operating environment of the target component, to orchestrate the target component.

In a third aspect of the present disclosure, an electronic device is provided, including: at least one processing unit; at least one memory, the at least one memory is coupled to the at least one processing unit and stores instructions executable by the at least one processing unit, the instructions, when executed by the at least one processing unit, causes the electronic device to perform the method described according to the first aspect of the present disclosure.

In a fourth aspect of the present disclosure, a computer-readable storage medium is provided, the computer-readable storage medium has machine-executable instructions stored thereon, the machine-executable instructions, when executed by a device, causes the device to perform the method described according to the first aspect of the present disclosure.

In a fifth aspect of the present disclosure, a computer program product is provided, including computer-executable instructions, where the computer-executable instructions, when executed by a processor, implement the method described according to the first aspect of the present disclosure.

The Summary section is provided to introduce a series of concepts in a simplified form, which will be further described in the Detailed Description section below. The Summary is not intended to identify key features or essential features of the present disclosure, nor is it intended to limit the scope of the present disclosure. Other features of the present disclosure will become readily understood through the following description.

### BRIEF DESCRIPTION OF THE DRAWINGS

FIG. 1 shows a schematic diagram of an example environment in which the embodiments of the present disclosure can be implemented;

FIG. 2 shows a flowchart of a method for orchestrating components according to an embodiment of the present disclosure;

FIG. 3A shows a schematic diagram of complementing a first interaction mode according to an embodiment of the present disclosure;

FIG. 3B shows a schematic diagram of complementing a second interaction mode according to an embodiment of the present disclosure;

FIG. 3C shows a schematic diagram of complementing a third interaction mode according to an embodiment of the present disclosure;

FIG. 3D shows a schematic diagram of complementing a fourth interaction mode according to an embodiment of the present disclosure;

FIG. 4A shows a schematic diagram of generating a target interaction mode set for a plurality of components according to an embodiment of the present disclosure;

FIG. 4B shows a schematic diagram of selecting a target interaction mode according to an embodiment of the present disclosure;

FIG. 5 shows a schematic diagram of a method for orchestrating components according to an embodiment of the present disclosure;

FIG. 6 shows a schematic diagram of a method for orchestrating components according to an embodiment of the present disclosure;

FIG. 7 shows a schematic diagram of a method for orchestrating components according to an embodiment of the present disclosure;

FIG. 8 shows a schematic block diagram of an example apparatus according to some embodiments of the present disclosure; and

FIG. 9 shows a block diagram of an example device that can be used to implement the embodiments of the present disclosure.

Throughout the drawings, the same or similar reference numbers refer to the same or similar elements.

### DETAILED DESCRIPTION OF EMBODIMENTS

The names of messages or information exchanged between multiple apparatuses in the implementations of the present disclosure are used for illustrative purposes only, and are not used to limit the scope of these messages or information. It may be understood that before using the technical solutions disclosed in the embodiments of the present disclosure, the user shall be informed of the type, range of use, use scenarios, etc. of personal information involved in the present disclosure in an appropriate manner and obtain the authorization of the user in accordance with relevant laws and regulations.

For example, in response to receiving an active request from a user, prompt information is sent to the user to clearly prompt the user that the requested operation will require access to and use of the user's personal information. As such, the user may independently choose, based on the prompt information, whether to provide the personal information to software or hardware, such as an electronic device, an application, a server, or a storage medium, that perform the operations of the technical solutions of the present disclosure. As an optional but non-limiting implementation, in response to receiving the active request from the user, the prompt information may be sent to the user in the form of, for example, a pop-up window, in which the prompt information may be presented in text. In addition, the pop-up window may also include a selection control for the user to select whether to "agree" or "disagree" to provide the personal information to the electronic device.

It may be understood that the above process of notifying and obtaining user authorization is only illustrative and does not limit the implementations of the present disclosure, and other methods that satisfy relevant laws and regulations may also be applied to the implementations of the present disclosure.

The embodiments of the present disclosure will be described in more detail below with reference to the drawings. Although some embodiments of the present disclosure are shown in the drawings, it should be understood that the present disclosure may be implemented in various forms and should not be construed as being limited to the embodiments set forth herein. Instead, these embodiments are provided for a more thorough and complete understanding of the present disclosure. It should be understood that the drawings and embodiments of the present disclosure are only used for illustrative purposes, and are not used to limit the protection scope of the present disclosure.

In the description of the embodiments of the present disclosure, the term "include/comprise" and similar terms should be understood as open-ended inclusions, that is, "include/comprise but not limited to". The term "based on" should be understood as "based at least in part on". The term "one embodiment" or "the embodiment" should be understood as "at least one embodiment". The terms "first", "second", etc. may refer to different or same objects, unless explicitly stated. Other definitions, either explicit or implicit, may also be included below.

When orchestrating components in an application development framework, developers of each component usually define an interaction mode of the component without prior communication, and different components often have different interaction modes. For example, component A is defined to receive non-streaming data and output non-streaming data, and component B is defined to receive streaming data and output streaming data. However, according to the business logic (such as functionality) of component A and component B, component A needs to be placed downstream of component B, which leads to the inability of component A and component B to interact. There are many such situations in the process of orchestrating multiple components together to form an orchestration result (that is, a result obtained after orchestrating components, for example, a graph including multiple components). Orchestrators need to select appropriate components according to the interaction mode of each component, or add dedicated data conversion components to the orchestration result. This leads to low efficiency in orchestrating components.

In this regard, the present disclosure proposes a method for orchestrating components. The method fine-tunes a defined interaction mode of a target component to generate an interaction mode set for the target component, so that the target component can support multiple interaction modes without changing its own business logic, and thus can flexibly meet various requirements for the form of input data and output data. Orchestrators do not need to consider the unification and conversion of interaction modes between components, which can significantly improve the efficiency of component orchestration.

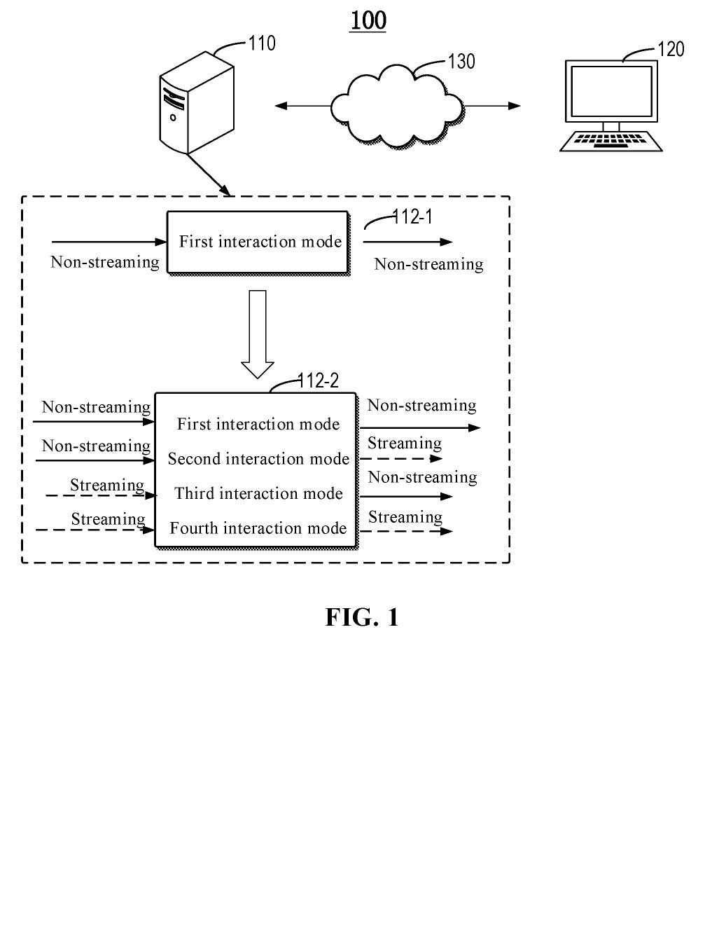

The embodiments of the present disclosure will be further described in detail below with reference to the drawings. FIG. 1 shows a schematic diagram of an example environment 100 in which the embodiments of the present disclosure can be implemented. The example environment 100 includes a computing device 110 and a computing device 120. The computing device 110 may process data and be deployed with an application development framework, such as a development framework for artificial intelligence applications, for providing orchestration services for user devices (such as the computing device 120) accessing the computing device 110. In some embodiments, the computing device 120 communicates with the computing device 110 via a network 130. The network 130 may include a wired network, a wireless network, or a combination thereof, for providing communication between the computing device 120 and the computing device 110. In some embodiments, the computing device 120 may be connected to the computing device 110 via a data cable, and the present disclosure does not limit the connection manner between the computing device 110 and the computing device 120.

The computing device 120 may provide multiple components to the computing device 110. Developers may complete the definition of various components on the computing device 120, and this definition may be implemented in multiple programming languages, which cover different levels from low-level to high-level and are suitable for different programming paradigms, including but not limited to Golang, C, JAVA, etc. For example, for an application scenario that requires tightly coupled hardware resources, the C language may be selected for development. As a procedural programming language, the C language not only provides the ability to operate underlying hardware, but also has good portability and execution efficiency. For another example, when the design of an application tends to utilize modularity, inheritance, and polymorphism, an object-oriented programming language may be used.

In this embodiment, the computing device 110 may determine at least one defined interaction mode of the target component according to a type of a parameter of a target component 112-1. As shown in FIG. 1, the target component 112-1 may be provided with a first interaction mode, and the first interaction mode allows the target component 112-1 to receive non-streaming data, process the input through business logic codes to generate an output, and output the output in a non-streaming manner, for example, outputting the output to a downstream component or as a final output of the orchestration result.

The computing device 110 may use the application development framework to generate an interaction mode set of the target component 112-2 based on the at least one defined interaction mode, the interaction mode set supporting a plurality of combinations of streaming input, non-streaming input, streaming output and non-streaming output. The generated interaction mode set includes a first interaction mode, a second interaction mode, a third interaction mode, and a fourth interaction mode. The interaction mode set may receive input data in various forms and generate output data in various forms. For example, the first interaction mode indicates that the input is non-streaming and the output is non-streaming, the second interaction mode indicates that the input is non-streaming and the output is streaming, the third interaction mode indicates that the input is streaming and the output is non-streaming, and the fourth interaction mode indicates that the input is streaming and the output is streaming. After the generation operation, the target component 112-1 is updated to the target component 112-2.

It should be noted that the generation of the interaction mode component may not modify any code logic of the target component itself, that is, the target component 112-1 and the target component 112-2 have the same code content (or business logic), and an interaction mode set (for example, multiple calling functions) may only be encapsulated outside the target component 112-1, so that when the target component 112-1 is called, the encapsulated function is first called according to the target interaction mode to process the input or output data, to convert the form of the data. During encapsulation, the computing device 110 may perform a data form conversion operation (such as a streaming operation and a packing operation), and then combine the data form conversion operation with the defined interaction mode of the target component 112-1, to obtain a specific interaction mode. For example, the streaming operation may be combined with the output data in the first interaction mode to form the second interaction mode.

The computing device 110 may select a target interaction mode of the target component 112-2 from the interaction mode set based on the operating environment of the target component, to orchestrate the target component. In the operating environment of the target component, the target component may flexibly set which interaction mode to use according to the needs of the environment. The computing device 110 selects, according to the actual operating environment requirements of the target component 112-1, a most suitable interaction mode from the generated interaction mode set as the target interaction mode. The selection basis may come from multiple aspects, such as user instructions, system configuration files, or automatically detected environmental characteristics. For example, if the operating environment requires that the component can receive and output streaming data, the computing device 110 selects the fourth interaction mode as the target interaction mode.

The user may also select "streaming data" or "non-streaming data" through an interface on the computing device 120, and convey this selection to the computing device 110 via the network 130, and the latter adjusts the interaction mode of the target component accordingly. For example, if the operating environment expects the target component to receive streaming input and generate streaming output, the interaction mode of the component may be set to the fourth interaction mode, that is, the fourth interaction mode is selected from the interaction mode set as the target interaction mode. The basis for selecting the interaction mode may be determined based on the input provided by the computing device 120. For example, the user may select one of "streaming data" and "non-streaming data" on the computing device 120. If the user selects "streaming data", the user instruction is sent to the computing device 110 via the network 130, and the application development framework on the computing device 110 selects the fourth interaction mode as the target interaction mode.

According to the method of the present disclosure, by preparing various interaction mode options for the target component 112-1 in advance, orchestrators do not need to worry about the consistency of interaction modes between different components or additional data format conversion work. This design greatly simplifies the system integration process and improves the speed and flexibility of component orchestration. Whether under static or dynamically changing workload conditions, the component can quickly adapt to new input/output requirements, ensuring the efficient operation of the entire orchestration result.

As shown in FIG. 1, in the environment 100, the network 130 may be used to transmit data between the computing device 110 and the computing device 120. The network 130 has a theoretical bandwidth, and the theoretical bandwidth refers to a maximum transmission speed supported by the network 130, which represents a maximum amount of data that the network 130 may transmit under ideal conditions, and is usually measured in bits per second (bps). For example, if the theoretical bandwidth of the network 130 is 100 Mbps, it means that under ideal conditions, it may transmit one hundred megabits of data per second. However, in practice, due to other factors that may exist in the network (for example, signal interference, bandwidth sharing, transmission delay, etc.), the actual transmission speed of 100 Mbps may not be achieved.

As understood by those of ordinary skill in the art, an instance of the computing device 110 may be an independent physical server, a server cluster or a distributed system composed of multiple physical servers, or may provide cloud services, cloud databases, cloud computing, cloud functions, cloud storage, network services, cloud communications, middleware services, domain name services, security services, CDNs, and basic cloud computing services such as big data and artificial intelligence platforms. The servers may be directly or indirectly connected by wired or wireless communication methods, which is not limited in the present application.

The computing device 120 may be any type of mobile computing device, including a mobile computer (e.g., a personal digital assistant (PDA), a laptop computer, a notebook computer, a tablet computer, a netbook, etc.), a mobile phone (e.g., a cellular phone, a smart phone, etc.), a wearable computing device (e.g., a smart watch, a head-mounted device, including smart glasses, etc.), or other types of mobile devices. In some embodiments, the computing device 120 may also be a stationary computing device, such as a desktop computer, a game console, a smart TV, etc.

It should be understood that the architecture and functions in the example environment 100 are described for illustrative purposes only, without suggesting any limitation to the scope of the present disclosure. The embodiments of the present disclosure may also be applied to other environments with different structures and/or functions.

The process according to the embodiments of the present disclosure will be described in detail below with reference to other drawings. For ease of understanding, the specific data mentioned in the following description is exemplary and is not used to limit the protection scope of the present disclosure. It may be understood that the embodiments described below may further include additional actions not shown and/or may omit the actions shown, and the scope of the present disclosure is not limited in this regard.

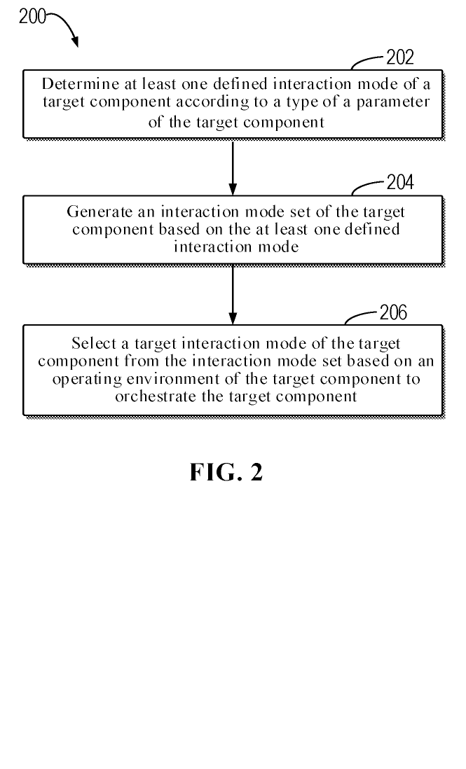

FIG. 2 shows a flowchart of a method 200 for orchestrating components according to some embodiments of the present disclosure. In this embodiment, the method may be performed by the computing device 110. At block 202, at least one defined interaction mode of a target component is determined according to a type of a parameter of the target component. When defining a function, the target component needs to set a type of a parameter to be processed and an identification thereof as a parameter. The parameter here may be the parameter passing in each function or method defined in the target component. For example, the computing device 110 may read, in the application development framework, the parameter passing of a function involved in receiving data in the target component, and determine, through the type of the parameter, whether the input data that may be received by the target component is streaming data or non-streaming data.

At block 204, an interaction mode set of the target component is generated based on the at least one defined interaction mode, the interaction mode set supporting a plurality of combinations of streaming input, non-streaming input, streaming output and non-streaming output. The target component may be a node that performs a certain function, and may also be a relatively independent module, which for example, may be embodied as a separate code file. The interaction mode of the target component refers to a form of data that the component may receive, such as streaming data or non-streaming data. In the target component, since the target component usually needs to receive data output by an upstream component, and process the data to generate output data, the target component defines a function of how to receive input data and a function of outputting data. These functions constitute the interaction mode of the target component.

Streaming input refers to continuously sending a data stream to the target component. Non-streaming input refers to providing all input data at once, such as file upload or form submission. Streaming output refers to continuously returning a processing result to a user or other system components in segments. Non-streaming output refers to outputting all data at once. Since the component is usually only provided with a few interaction modes, orchestrating only based on the interaction modes provided by the component itself will reduce the efficiency of component orchestration. In this operation, the computing device 110 generates an interaction mode set supporting multiple data forms for the target component, which means that the target component may flexibly receive various forms of data and generate corresponding output according to actual needs.

At block 206, a target interaction mode of the target component is selected from the interaction mode set based on an operating environment of the target component, to orchestrate the target component. In an embodiment, the target interaction mode may be selected according to requirements of the operating environment, such as whether real-time processing capability is required or whether the application scenario is latency-sensitive. In an embodiment, the target interaction mode may be selected according to an adjustment of the operating environment by user instructions, for example, allowing the user to select "streaming data" or "non-streaming data" through an interface and convey it to the computing device 110 via the network 130, and the latter adjusts the interaction mode of the target component accordingly. In an embodiment, the target interaction mode may be selected by automatically detecting the operating environment, for example, the computing device 110 may identify an optimal interaction mode through an automatic detection mechanism without manual intervention.

According to the method of the embodiments of the present disclosure, an interaction mode set is generated for the target component by fine-tuning a defined interaction mode of the target component, so that the target component can support multiple interaction modes without changing the business logic of the target component itself, and thus can flexibly meet various requirements for forms of input data and output data, and an orchestrator does not need to consider unification and conversion of interaction modes between components, which can significantly improve efficiency of component orchestration.

For the generation of the interaction mode set, in an embodiment, a differential interaction mode set for the target component is determined according to the at least one defined interaction mode and an interaction mode set to be generated. The interaction mode set to be generated represents a plurality of combinations (such as four) of data forms of input and output, which may be a complete set of interaction modes. By comparing the interaction mode set with the defined interaction mode of the target component, deficiencies may be identified and addressed. It should be noted that the target interaction mode set to be generated is not an interaction mode set with a complete and specific definition of each interaction mode, but a declaration indicating a combination of various interaction modes supported by the target interaction mode. For example, the target interaction mode set to be generated may indicate that it is necessary to generate interaction functions including the first interaction mode, the second interaction mode, the third interaction mode, the fourth interaction mode, and interaction functions of each interaction mode.

In an embodiment, the interaction mode set is obtained by supplementing interaction modes of the target component with the differential interaction mode set. The missing interaction mode may be supplemented based on the at least one defined interaction mode of the target component. In this embodiment, by determining the differential interaction mode set, the interaction mode that needs to be supplemented may be determined, so that an interaction mode set covering a plurality of combinations may be generated for the target component, which may facilitate the generation of the interaction mode set.

In an embodiment, the interaction mode set includes multiple interaction modes of a first interaction mode, a second interaction mode, a third interaction mode, and a fourth interaction mode, the first interaction mode indicates that an input is non-streaming and an output is non-streaming, the second interaction mode indicates that an input is non-streaming and an output is streaming, the third interaction mode indicates that an input is streaming and an output is non-streaming, and the fourth interaction mode indicates that an input is streaming and an output is streaming. For an interaction mode set covering the first to fourth interaction modes, the target component may receive both streaming data and non-streaming data, and may output both streaming data and non-streaming data. By generating a set that covers more interaction modes, the efficiency of component orchestration may be improved.

When supplementing the interaction modes of each component based on the interaction mode defined by the component to generate the target interaction mode set, there is no need to modify code content of the component, and a function (or method) that implements the defined interaction mode may be used to encapsulate some operations on the component, such as a streaming operation and a packing operation, and combine the function that implements the defined interaction mode with the encapsulated function to form a new interaction mode.

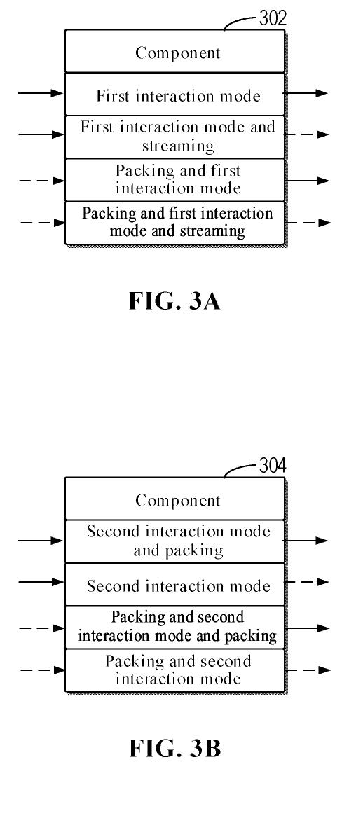

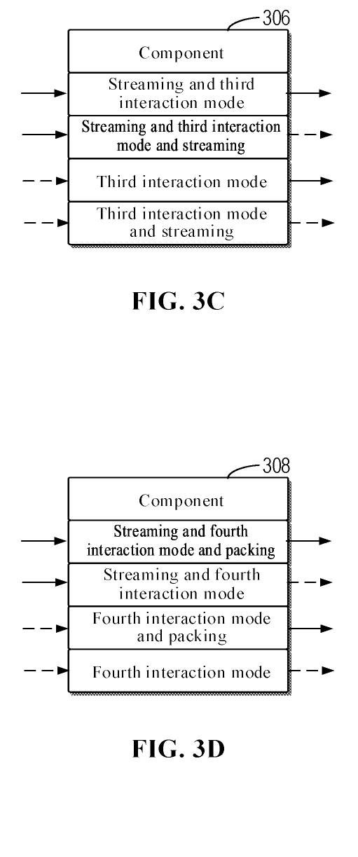

FIG. 3A shows a schematic diagram of complementing the first interaction mode according to an embodiment of the present disclosure. In an embodiment, if the differential interaction mode set includes the second interaction mode and the at least one defined interaction mode includes the first interaction mode, the data output by the target component through the first interaction mode is processed using a streaming operation, to obtain the second interaction mode. As shown in FIG. 3A, for the component 302, the data output by the component 302 through the first interaction mode is processed using the streaming operation, to obtain streaming data. In this way, the component 302 may support non-streaming input and streaming output.

In an embodiment, if the differential interaction mode set includes the third interaction mode and the at least one defined interaction mode includes the first interaction mode, the data input by the target component through the first interaction mode is processed using a packing operation, to obtain the third interaction mode. As shown in FIG. 3A, for the component 302, the input data is processed using the packing operation and the processed input data is input to the first interaction mode of the component 302, and the output function of the component 302 (that is, the function supporting the first interaction mode) may generate a non-streaming output, so that the component 302 may support streaming input and non-streaming output.

In an embodiment, if the differential interaction mode set includes the fourth interaction mode and the at least one defined interaction mode includes the first interaction mode, the input data is processed using the packing operation and the processed input data is input to the first interaction mode of the target component, and the data output by the target component through the first interaction mode is processed using the streaming operation, to obtain the fourth interaction mode. As shown in FIG. 3A, for the component 302, the streaming data is received and processed using the packing operation to be converted into non-streaming data, which is then transmitted to the input function of the component 302, and the non-streaming data output by the output function of the component 302 is processed using the streaming operation to generate a streaming output. In this way, the component 302 may support streaming input and streaming output.

FIG. 3B shows a schematic diagram of complementing the second interaction mode according to an embodiment of the present disclosure. In an embodiment, if the differential interaction mode set includes the first interaction mode and the at least one defined interaction mode includes the second interaction mode, the data output by the target component through the second interaction mode is processed using a packing operation, to obtain the first interaction mode. As shown in FIG. 3B, for the component 304, the data output by the output function of the component 304 is processed using the packing operation, to output non-streaming data, so that the component 304 may support non-streaming input and non-streaming output.

In an embodiment, if the differential interaction mode set includes the third interaction mode and the at least one defined interaction mode includes the second interaction mode, the input data is processed using the packing operation and the processed input data is input to the second interaction mode of the target component, and the data output by the target component through the second interaction mode is processed using the packing operation, to obtain the third interaction mode. As shown in FIG. 3B, for the component 304, the streaming data is received and processed using the packing operation to be converted into non-streaming data, which is then transmitted to the input function of the component 304, and the streaming data output by the output function of the component 304 is processed using the packing operation to generate a non-streaming output. In this way, the component 304 may support streaming input and non-streaming output.

In an embodiment, if the differential interaction mode set includes the fourth interaction mode and the at least one defined interaction mode includes the second interaction mode, the input data is processed using the packing operation and the processed input data is input to the second interaction mode of the target component, to obtain the fourth interaction mode. As shown in FIG. 3B, for the component 304, the streaming data is received and processed using the packing operation to be packed into non-streaming data, and then the non-streaming data is transmitted to the input function of the component 304, and the component 304 may generate a streaming output based on its own output function, so that the component 304 may support streaming input and streaming output.

FIG. 3C shows a schematic diagram of complementing the third interaction mode according to an embodiment of the present disclosure. In an embodiment, if the differential interaction mode set includes the first interaction mode and the at least one defined interaction mode includes the third interaction mode, the input data is processed using a streaming operation and the processed input data is input to the third interaction mode of the target component, to obtain the first interaction mode. As shown in FIG. 3C, for the component 306, the non-streaming input data is processed using the streaming operation and is converted into streaming data, which is transmitted to the input function of the component 306, so that the component 306 may support non-streaming input. The output function of the component 306 may generate non-streaming data, so the component 306 may support non-streaming output.

In an embodiment, if the differential interaction mode set includes the second interaction mode and the at least one defined interaction mode includes the third interaction mode, the input data is processed using the streaming operation and the processed input data is input to the third interaction mode of the target component, and the data output by the target component through the third interaction mode is processed using the streaming operation, to obtain the second interaction mode. As shown in FIG. 3C, for the component 306, the non-streaming input data is processed using the streaming operation and is converted into streaming data, which is transmitted to the input function of the component 306, so that the component 306 may support non-streaming input. The output function of the component 306 may generate non-streaming data, and the non-streaming data is processed using the streaming operation to generate a streaming output, so that the component 306 may support streaming output.

In an embodiment, if the differential interaction mode set includes the fourth interaction mode and the at least one defined interaction mode includes the third interaction mode, the data output by the target component through the third interaction mode is processed using the streaming operation, to obtain the fourth interaction mode. As shown in FIG. 3C, for the component 306, the output function of the component 306 may generate non-streaming data, and the non-streaming data is processed using the streaming operation to generate a streaming output, so that the component 306 may support streaming input and streaming output.

FIG. 3D shows a schematic diagram of complementing the fourth interaction mode according to an embodiment of the present disclosure. In an embodiment, if the differential interaction mode set includes the first interaction mode and the at least one defined interaction mode includes the fourth interaction mode, the input data is processed using the streaming operation and the processed input data is input to the fourth interaction mode of the target component, and the data output by the target component through the fourth interaction mode is processed using the packing operation, to obtain the first interaction mode. As shown in FIG. 3D, for the component 308, the non-streaming input data is processed using the streaming operation to obtain streaming data, which is transmitted to the input function of the component 308. The output function of the component 308 may generate streaming data, and the streaming data is processed using the packing operation to generate a non-streaming output, so that the component 308 may support non-streaming input and non-streaming output.

In an embodiment, if the differential interaction mode set includes the second interaction mode and the at least one defined interaction mode includes the fourth interaction mode, the input data is processed using the streaming operation and the processed input data is input to the fourth interaction mode of the target component, to obtain the second interaction mode. As shown in FIG. 3D, for the component 308, the non- streaming input data is processed using the streaming operation to obtain streaming data, which is transmitted to the input function of the component 308. The output function of the component 308 may generate streaming data, so that the component 308 may support non-streaming input and streaming output.

In an embodiment, if the differential interaction mode set includes the third interaction mode and the at least one defined interaction mode includes the fourth interaction mode, the data output by the target component through the fourth interaction mode is processed using the packing operation, to obtain the third interaction mode. As shown in FIG. 3D, for the component 308, the output function of the component 308 may generate streaming data, and the streaming data is processed using the packing operation, thereby generate a non-streaming output, so that the component 308 may support streaming input and non-streaming output.

The above embodiments provide a solution to cover all interaction modes based on different defined interaction modes, which may expand the interaction modes of the target component without modifying the code content (or business logic) of the component, making the interaction of the target component more flexible. In an embodiment, each interaction mode in the differential interaction mode set is encapsulated into the target component. For example, the computing device 110 may set a target structure according to the at least one defined interaction mode. The target structure may define how to provide a streaming function or a packing function for different interaction modes. If the target component includes any of the at least one defined interaction mode, the computing device 110 may encapsulate the target structure into the target component. This implementation may expand the interaction modes of the component simply and quickly, without the need to add too much coding content to the component.

In an embodiment, the packing operation may be to use a packing function to sequentially combine a plurality of first data blocks into second data. In an embodiment, the streaming operation may be to use a streaming function to sequentially split a third data block into multiple fourth data blocks.

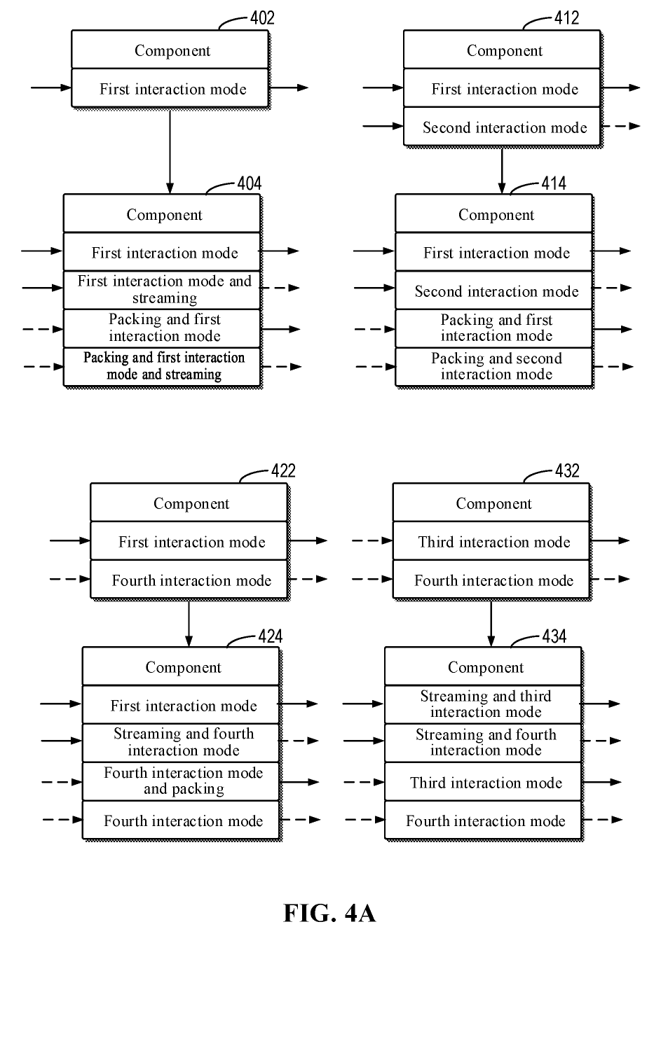

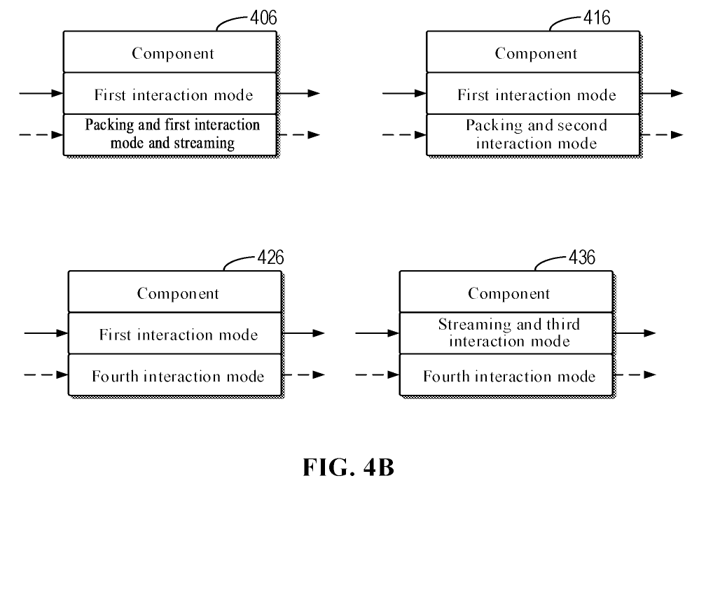

FIG. 4A shows a schematic diagram of generating target interaction mode sets for multiple components according to an embodiment of the present disclosure. This embodiment shows the processing of four components, which are component 402, component 412, component 422, and component 432, respectively. According to the types of the parameters of each component, it may be determined that the component 402 defines the first interaction mode, the component 412 defines the first interaction mode and the second interaction mode, the component 422 defines the first interaction mode and the fourth interaction mode, and the component 432 defines the third interaction mode and the fourth interaction mode. In an embodiment, the form of data that may be received may be determined according to the type of the parameter of the function that receives input in the components 402, 412, 422, 432, and the form of data that may be output may be determined according to the type of the parameter of the function that generates output, thereby determining which interaction modes have been defined by each component.

When supplementing the interaction mode of each component based on the interaction mode defined by the component to generate the target interaction mode set, if the component has multiple interaction modes, other interaction modes may be supplemented according to any of the interaction modes. For the component 402, the defined interaction mode only includes the first interaction mode, and therefore the interaction mode set for the component 402 may be obtained by the complementing indicated by 416. For the component 412, the defined interaction modes include the first interaction mode and the second interaction mode, and therefore the interaction mode set for the component 412 may be obtained by the complementing indicated by 414, where the third interaction mode is supplemented based on the first interaction mode, and the fourth interaction mode is supplemented based on the second interaction mode.

For the component 422, the defined interaction modes include the first interaction mode and the fourth interaction mode, and therefore the interaction mode set for the component 422 may be obtained by the complementing indicated by 424, where the second interaction mode is supplemented based on the fourth interaction mode, and the fourth interaction mode is further supplemented based on the fourth interaction mode. For the component 432, the defined interaction modes include the third interaction mode and the second interaction mode, and therefore the interaction mode set for the component 432 may be obtained by the complementing indicated by 434, where the first interaction mode is supplemented based on the third interaction mode, and the second interaction mode is supplemented based on the fourth interaction mode.

FIG. 4B shows a schematic diagram of selecting a target interaction mode according to an embodiment of the present disclosure, including a component 406, a component 416, a component 426, and a component 436. The embodiment of FIG. 4B is a continuation of the embodiment of FIG. 4A. When selecting the target interaction mode, it may be determined according to the operating environment of the target component. If the user indicates that the operating environment of the target component is a non-streaming environment, for the sake of simplicity, the target interaction mode of each component may be uniformly set to non-streaming input and non-streaming output. For example, the component 406 may use the first interaction mode, the component 416 may use the first interaction mode, the component 426 may use the first interaction mode, and the component 436 may use the first interaction mode obtained by combining the streaming operation and the third interaction mode, where the streaming operation is used to process the input data, and the generated streaming data is transmitted to the input function of the component 436 (which may only receive streaming input), so that the component 436 may support non-streaming input and generate non-streaming output.

If the user indicates that the operating environment of the target component is a streaming environment, for the sake of simplicity, the target interaction mode of each component may be uniformly set to streaming input and streaming output. For example, the component 406 may use a combination of the packing operation, the first interaction mode, and the streaming operation to implement the fourth interaction mode, where the packing operation is used to process the input data and input the processed input data to the first interaction mode of the component 406, and the streaming operation is used to process the output data of the first interaction mode. For example, the component 416 may use a combination of the packing operation and the second interaction mode to implement the fourth interaction mode, where the packing operation is used to process the input data and input the processed input data to the second interaction mode of the component 408. For example, the component 426 may use the fourth interaction mode. The component 436 may use the fourth interaction mode. In this embodiment, the target interaction mode adapted to the operating environment is selected based on the interaction mode defined by each component, which improves the flexibility of the component and the efficiency of adapting to the operating environment.

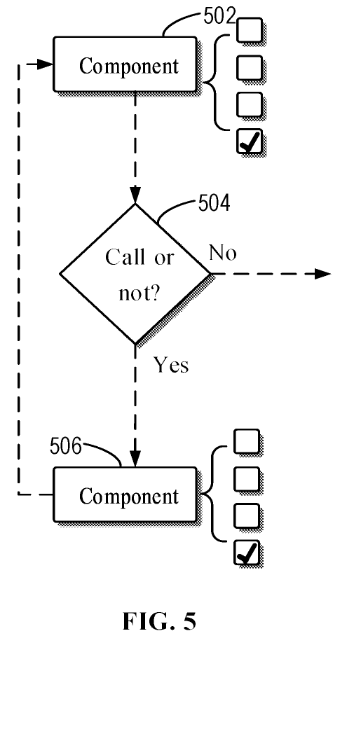

FIG. 5 shows a schematic diagram of a method for orchestrating components according to an embodiment of the present disclosure. In this embodiment, the component 502 and the component 506 need to be orchestrated to form an orchestration result. However, the code content of the component 502 only supports the second interaction mode, and the code content of the component 506 only supports the first interaction mode. In order to achieve the desired effect, for example, the component 502 involves the use of a large language model, at a branch 504, when the data generated by the component 502 needs to be presented, it is required to output streaming data. At the branch 504, when the component 502 needs to call the component 506, the component 502 needs to generate a non-streaming output, otherwise the component 506 cannot receive the output data of the component 502.

In this case, the interaction modes of the component 502 and the component 506 may be expanded according to the embodiments of the present disclosure, and the target interaction mode of the component 502 and the component 506 may be determined as the fourth interaction mode according to the operating environment. In this way, the component 502 may either generate a streaming output and present the output directly, or directly transmit the streaming output to the component 506, and the component 506 may directly receive the streaming output and process it. Developers do not need to adapt any independent components for converting data forms on the basis of the component 502 and the component 506. Therefore, the efficiency of component orchestration may be significantly improved.

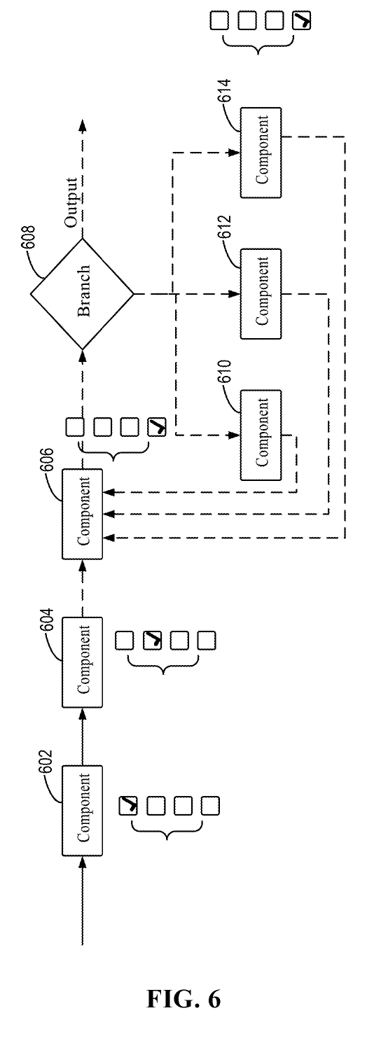

FIG. 6 shows a schematic diagram of a method for orchestrating components according to an embodiment of the present disclosure. This embodiment includes a component 602, a component 604, a component 606, a component 610, a component 612, and a component 614. The components 602 and 604 define the first interaction mode, the component 606 defines the fourth interaction mode, and the components 610, 612, and 614 define the second interaction mode. In this case, the component 606 cannot receive the output data generated by the component 604, because the output data is non-streaming data. At a branch 608, if the output data generated by the component 606 needs to be presented, the output data is required to be output in a streaming manner. At the branch 608, if the component 606 needs to call any one or more of the components 610, 612, and 614, the component 606 needs to transmit the output data to the components 610, 612, and 614, and the component 606 needs to generate a non-streaming output, otherwise the components 610, 612, and 614 cannot receive the output data generated by the component 606.

After expansion based on the interaction mode defined by each component, each component may have an interaction mode set. As an example, for the component 602, the first interaction mode may be selected as the target interaction mode. For the component 604, the second interaction mode may be selected as the target interaction mode. For the component 606, the fourth interaction mode may be selected as the target interaction mode. For the components 610, 612, and 614, the fourth interaction mode may be selected as the target interaction mode. In this way, each upstream and downstream component can seamlessly interact, thereby implementing the corresponding task.

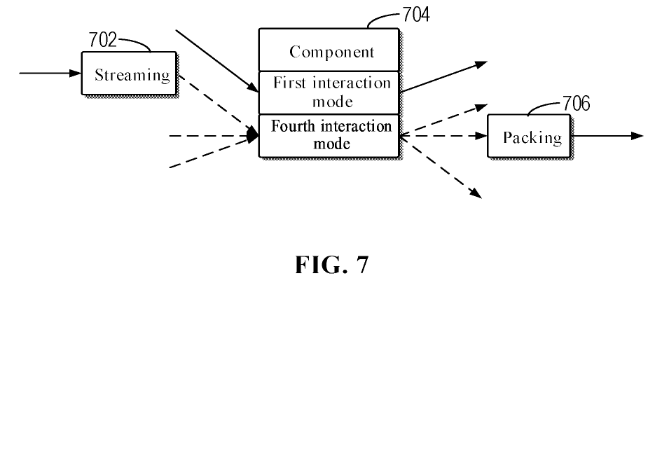

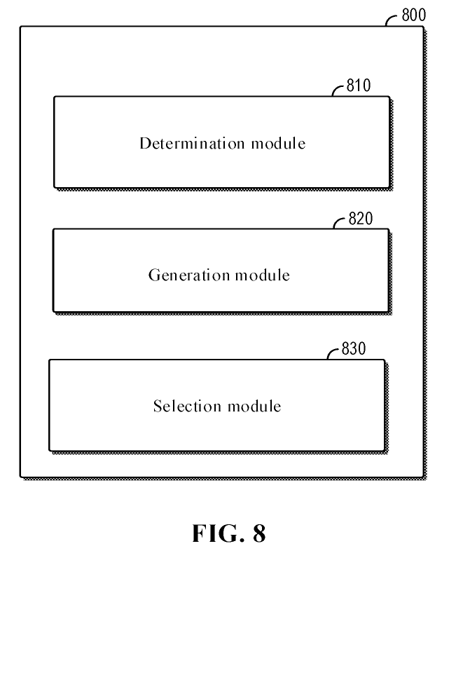

FIG. 7 shows a schematic diagram of a method for orchestrating components according to an embodiment of the present disclosure. In this embodiment, the component 704 itself may also be an orchestration result, that is, the component 704 is obtained by orchestrating multiple components. When selecting the target interaction mode according to the operating environment, the interaction mode of the component 704 may be determined as the first interaction mode or the second interaction mode. This means that the defined interaction modes of the component 704 include the first interaction mode and the fourth interaction mode. Although the component 704 also belongs to the orchestration result, the interaction mode of the component 704 may still be expanded using the embodiment described above, that is, generating the interaction mode set based on the defined interaction modes, and selecting the target interaction mode from the interaction mode set according to the operating environment.

For example, when expanding the second interaction mode, the streaming operation may be used to process the non-streaming input data to generate streaming data, and the streaming data is transmitted to the fourth interaction mode of the component 704 to generate a streaming output, so that the component 704 may support non-streaming input and streaming output. For another example, when expanding the third interaction mode, the component 704 may use the fourth interaction mode to receive the input data and generate a streaming output, and the packing operation may be used to receive the output of the component 704, thereby generating non-streaming data as a non-streaming output, so that the component 704 may support streaming output and non-streaming output. According to the embodiments of the present disclosure, the interaction mode of the orchestration result may be expanded, thereby improving the efficiency of component orchestration.

FIG. 8 shows a schematic block diagram of an example apparatus 800 according to some embodiments of the present disclosure. The apparatus 800 may be implemented in a software, a hardware, or a combination thereof. As shown in FIG. 8, the apparatus 800 includes a determination module 810, a generation module 820, and a selection module 830.

In some embodiments, the acquisition module 810 may be configured to determine the at least one defined interaction mode of the target component according to a type of a parameter of the target component. The generation module 820 may be configured to generate the interaction mode set of the target component, the interaction mode set supporting a plurality of combinations of streaming input, non-streaming input, streaming output, and non-streaming output. The selection module 830 may be configured to select the target interaction mode of the target component from the interaction mode set based on the operating environment of the target component, to orchestrate the target component.

In some embodiments, the generation module 820 includes a second determination module, which is configured to determine a differential interaction mode set for the target component according to the at least one defined interaction mode and an interaction mode set to be generated. The generation module 820 further includes a differential supplement module, which is configured to supplement interaction modes of the target component by using the differential interaction mode set to obtain the interaction mode set.

In some embodiments, the interaction mode set includes a plurality of interaction modes of a first interaction mode, a second interaction mode, a third interaction mode, and a fourth interaction mode, the first interaction mode indicates that an input is non-streaming and an output is non-streaming, the second interaction mode indicates that an input is non-streaming and an output is streaming, the third interaction mode indicates that an input is streaming and an output is non-streaming, and the fourth interaction mode indicates that an input is streaming and an output is streaming.

In some embodiments, the generation module 820 includes a first supplement module, which is configured to, in response to the differential interaction mode set including the second interaction mode and the at least one defined interaction mode including the first interaction mode, process, using a streaming operation, data output by the target component through the first interaction mode, to obtain the second interaction mode; or in response to the differential interaction mode set including the third interaction mode and the at least one defined interaction mode including the first interaction mode, process input data using a packing operation and input processed input data into the first interaction mode of the target component, to obtain the third interaction mode; or in response to the differential interaction mode set including the fourth interaction mode and the at least one defined interaction mode including the first interaction mode, process input data using a packing operation and input processed input data into the first interaction mode of the target component, and process, using the streaming operation, data output by the target component through the first interaction mode, to obtain the fourth interaction mode.

In some embodiments, the generation module 820 includes a second supplement module, which is configured to, in response to the differential interaction mode set including the first interaction mode and the at least one defined interaction mode including the second interaction mode, process, using a packing operation, data output by the target component through the second interaction mode, to obtain the first interaction mode; or in response to the differential interaction mode set including the third interaction mode and the at least one defined interaction mode including the second interaction mode, process input data using the packing operation and input processed input data into the second interaction mode of the target component, and process, using the packing operation, data output by the target component through the second interaction mode, to obtain the third interaction mode; or in response to the differential interaction mode set including the fourth interaction mode and the at least one defined interaction mode including the second interaction mode, process input data using the packing operation and input processed input data into the second interaction mode of the target component, to obtain the fourth interaction mode.

In some embodiments, the generation module 820 includes a third supplement module, which is configured to, in response to the differential interaction mode set including the first interaction mode and the at least one defined interaction mode including the third interaction mode, process input data using a streaming operation and input processed input data into the third interaction mode of the target component, to obtain the first interaction mode; or in response to the differential interaction mode set including the second interaction mode and the at least one defined interaction mode including the third interaction mode, process input data using the streaming operation and input processed input data into the third interaction mode of the target component, and process, using the streaming operation, data output by the target component through the third interaction mode, to obtain the second interaction mode; or in response to the differential interaction mode set including the fourth interaction mode and the at least one defined interaction mode including the third interaction mode, process, using the streaming operation, data output by the target component through the third interaction mode, to obtain the fourth interaction mode.

In some embodiments, the generation module 820 includes a fourth supplement module, which is configured to, in response to the differential interaction mode set including the first interaction mode and the at least one defined interaction mode including the fourth interaction mode, process input data using the streaming operation and input processed input data into the fourth interaction mode of the target component, and process, using a packing operation, data output by the target component through the fourth interaction mode, to obtain the first interaction mode; or in response to the differential interaction mode set including the second interaction mode and the at least one defined interaction mode including the fourth interaction mode, process input data using the streaming operation and input processed input data into the fourth interaction mode of the target component, to obtain the second interaction mode; or in response to the differential interaction mode set including the third interaction mode and the at least one defined interaction mode including the fourth interaction mode, process, using the packing operation, data output by the target component through the fourth interaction mode, to obtain the third interaction mode.

In some embodiments, the packing operation is a packing function that sequentially combines a plurality of first data blocks into second data in sequence.

In some embodiments, the streaming operation is a streaming function that sequentially splits a third data block into a plurality of fourth data blocks in sequence.

In some embodiments, the differential supplement module includes a first encapsulation module, which is configured to encapsulate each interaction mode in the differential interaction mode set into the target component.

In some embodiments, the first encapsulation module includes a setting module, which is configured to set a target structure according to the at least one defined interaction mode. The first encapsulation module further includes a second encapsulation module, which is configured to encapsulate the target structure into the target component in response to the target component including any of the at least one defined interaction mode.

The apparatus according to the embodiments of the present disclosure generates the interaction mode set for the target component by fine-tuning the interaction mode defined by the target component, so that the target component may support various interaction modes without changing its own business logic, thereby being able to flexibly meet various requirements for the forms of the input data and the output data, and the orchestrator does not need to consider the unification and conversion of the interaction modes between the components, which may significantly improve the efficiency of component orchestration.

The division of modules or units in the embodiments of the present disclosure is schematic, and is only a logical function division. In an actual implementation, there may be other division methods. In addition, the functional units in the disclosed embodiments may be integrated into one unit, each unit may be physically displayed separately, or two or more units may be integrated into one unit. The above integrated unit may be implemented in a form of hardware or a form of software functional units.

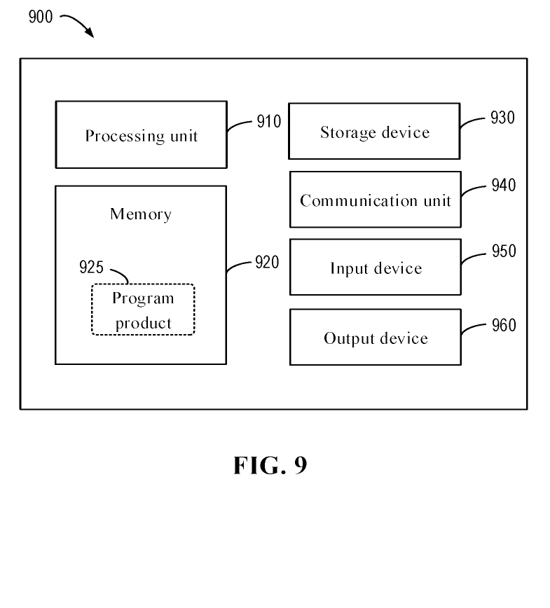

FIG. 9 shows a block diagram of an example device 900 that may be used to implement the embodiments of the present disclosure. It should be understood that the device 900 shown in FIG. 9 is only an example, and should not constitute any limitation on the functions and scope of the implementations described herein. For example, the device 900 may correspond to the computing device 120 described herein in conjunction with FIG. 1, and may be used to perform the processes of FIGS. 1 to 7B described above.

As shown in FIG. 9, the device 900 is in a form of a general computing device. The components of the computing device 900 may include, but are not limited to, one or more processors or processing units 910, a memory 920, a storage device 930, one or more communication units 940, one or more input devices 950, and one or more output devices 960. The processing unit 910 may be an actual or virtual processor, and may perform various processing according to the program stored in the memory 920. In a multi-processor system, multiple processing units execute computer-executable instructions in parallel to improve the parallel processing capability of the computing device 900.

The computing device 900 typically includes multiple computer storage medium. Such medium may be any available medium that is accessible to the computing device 900, including, but not limited to, volatile and non-volatile medium, removable and non-removable medium. The memory 920 may be volatile memory (for example, a register, a cache, a Random Access Memory (RAM)), a non-volatile memory (such as a Read Only Memory (ROM), an Electrically Erasable Programmable Read Only Memory (EEPROM), a flash memory), or any combination thereof. The storage device 930 may be any removable or non-removable medium, and may include a machine-readable medium such as a flash drive, a disk, or any other medium, which may be used to store information and/or data (such as training data for training) and may be accessed within the computing device 900.

The computing device 900 may further include additional removable/non-removable, volatile/non-volatile memory medium. Although not shown in FIG. 9, a disk drive for reading from or writing to a removable, non-volatile disk (such as a "floppy disk"), and an optical disk drive for reading from or writing to a removable, non-volatile optical disk may be provided. In these cases, each drive may be connected to the bus (not shown) by one or more data medium interfaces. The memory 920 may include a computer program product 925, which has one or more program modules configured to perform various methods or acts of various implementations of the present disclosure.

The communication unit 940 implements communication with other computing devices through the communication medium. Additionally, the functions of the components of the computing device 900 may be implemented by a single computing cluster or multiple computing machines, which may communicate through communication connections. Therefore, the computing device 900 may use a logical connection with one or more other servers, a network Personal Computer (PC), or another network node to operate in a networked environment.

The input device 950 may be one or more input devices, such as a mouse, a keyboard, a tracking ball, etc. The output device 960 may be one or more output devices, such as a display, a speaker, a printer, etc. The computing device 900 may also communicate with one or more external devices (not shown) such as a storage device, a display device, etc., with one or more devices that enable a user to interact with the computing device 900, or with any devices (e.g., a network card, a modem, etc.) that enable the computing device 900 to communicate with one or more other computing devices via the communication unit 940, as needed. Such communication may be performed via an Input/Output (I/O) interface (not shown).

According to an example implementation of the present disclosure, a computer-readable storage medium is provided, having computer-executable instructions stored thereon, where the computer-executable instructions are executed by a processor to implement the method described above. According to an example implementation of the present disclosure, there is further provided a computer program product tangibly stored on a non-transitory computer-readable medium and including computer-executable instructions, where the computer-executable instructions are executed by a processor to implement the method described above. According to an example implementation of the present disclosure, a computer program product is provided, having a computer program stored thereon, where the program, when executed by a processor, implements the method described above.

Various aspects of the present disclosure are described herein with reference to flowcharts and/or block diagrams of methods, apparatuses, devices, and computer program products implemented according to the present disclosure. It should be understood that each block of the flowchart and/or block diagram, and combinations of blocks in the flowchart and/or block diagram, may be implemented by computer-readable program instructions.

These computer-readable program instructions may be provided to a processing unit of a general-purpose computer, a special-purpose computer, or other programmable data processing apparatus to produce a machine, such that the instructions, when executed by the processing unit of the computer or other programmable data processing apparatus, produce an apparatus for implementing the functions/acts specified in one or more blocks of the flowchart and/or block diagram. These computer-readable program instructions may also be stored in a computer-readable storage medium, and these instructions cause a computer, a programmable data processing apparatus, and/or other devices to work in a specific manner, so that the computer-readable medium storing the instructions includes a manufactured product, which includes instructions for implementing various aspects of the functions/acts specified in one or more blocks of the flowchart and/or the block diagram.

The computer-readable program instructions may be loaded onto a computer, other programmable data processing apparatus, or other devices, so that a series of operations and steps are performed on the computer, other programmable data processing apparatus, or other devices to produce a computer-implemented process, so that the instructions executed on the computer, other programmable data processing apparatus, or other devices implement the functions/acts specified in one or more blocks of the flowchart and/or block diagram.

The flowcharts and block diagrams in the drawings show the possibly implemented architectures, functions, and operations of the system, method, and computer program product according to multiple implementations of the present disclosure. In this regard, each block in the flowchart or block diagram may represent a module, program segment, or part of an instruction, which contains one or more executable instructions for implementing the specified logical function. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagram and/or the flowchart, and the combination of the blocks in the block diagram and/or the flowchart may be implemented by a dedicated hardware-based system that performs specified functions or acts, or may be implemented by a combination of dedicated hardware and computer instructions.

The implementations of the present disclosure have been described above, and the above description is exemplary, non-exhaustive, and not limited to the disclosed implementations. Without departing from the scope and spirit of the illustrated implementations, many modifications and changes will be apparent to those of ordinary skill in the art. The terms used herein are chosen to best explain the principles, practical applications, or improvements to the technology in the market of the implementations, or to enable other those of ordinary skill in the art to understand the implementations disclosed herein.

We claim:

1. A method for orchestrating components, comprising:
determining at least one defined interaction mode of a target component according to a type of a parameter of the target component;
generating an interaction mode set of the target component based on the at least one defined interaction mode, the interaction mode set supporting a plurality of combinations of streaming input, non-streaming input, streaming output and non-streaming output; and
selecting a target interaction mode of the target component from the interaction mode set based on an operating environment of the target component, to orchestrate the target component.

2. The method of claim 1, wherein generating the interaction mode set of the target component based on the at least one defined interaction mode comprises:
determining a differential interaction mode set for the target component according to the at least one defined interaction mode and an interaction mode set to be generated; and
supplementing interaction modes of the target component by using the differential interaction mode set, to obtain the interaction mode set.

3. The method of claim 2, wherein the interaction mode set comprises a plurality of interaction modes of a first interaction mode, a second interaction mode, a third interaction mode, and a fourth interaction mode, the first interaction mode indicates that an input is non-streaming and an output is non-streaming, the second interaction mode indicates that an input is non-streaming and an output is streaming, the third interaction mode indicates that an input is streaming and an output is non-streaming, and the fourth interaction mode indicates that an input is streaming and an output is streaming.

4. The method of claim 3, wherein supplementing the interaction modes of the target component by using the differential interaction mode set, to obtain the interaction mode set comprises:
in response to the differential interaction mode set comprising the second interaction mode and the at least one defined interaction mode comprising the first interaction mode, processing, using a streaming operation, data output by the target component through the first interaction mode, to obtain the second interaction mode;
in response to the differential interaction mode set comprising the third interaction mode and the at least one defined interaction mode comprising the first interaction mode, processing input data using a packing operation and inputting the processed input data into the first interaction mode of the target component, to obtain the third interaction mode; or
in response to the differential interaction mode set comprising the fourth interaction mode and the at least one defined interaction mode comprising the first interaction mode, processing the input data using the packing operation and inputting the processed input data into the first interaction mode of the target component, and processing, using the streaming operation, data output by the target component through the first interaction mode, to obtain the fourth interaction mode.

5. The method of claim 3, wherein supplementing the interaction modes of the target component by using the differential interaction mode set, to obtain the interaction mode set comprises:
in response to the differential interaction mode set comprising the first interaction mode and the at least one defined interaction mode comprising the second interaction mode, processing, using a packing operation, data output by the target component through the second interaction mode, to obtain the first interaction mode;
in response to the differential interaction mode set comprising the third interaction mode and the at least one defined interaction mode comprising the second interaction mode, processing input data using the packing operation and inputting the processed input data into the second interaction mode of the target component, and processing, using the packing operation, data output by the target component through the second interaction mode, to obtain the third interaction mode; or
in response to the differential interaction mode set comprising the fourth interaction mode and the at least one defined interaction mode comprising the second interaction mode, processing the input data using the packing operation and inputting the processed input data into the second interaction mode of the target component, to obtain the fourth interaction mode.

6. The method of claim 3, wherein supplementing the interaction modes of the target component by using the differential interaction mode set, to obtain the interaction mode set comprises:
in response to the differential interaction mode set comprising the first interaction mode and the at least one defined interaction mode comprising the third interaction mode, processing input data using a streaming operation and inputting the processed input data into the third interaction mode of the target component, to obtain the first interaction mode;
in response to the differential interaction mode set comprising the second interaction mode and the at least one defined interaction mode comprising the third interaction mode, processing the input data using the streaming operation and inputting the processed input data into the third interaction mode of the target component, and processing, using the streaming operation, data output by the target component through the third interaction mode, to obtain the second interaction mode; or
in response to the differential interaction mode set comprising the fourth interaction mode and the at least one defined interaction mode comprising the third interaction mode, processing, using the streaming operation, data output by the target component through the third interaction mode, to obtain the fourth interaction mode.

7. The method of claim 3, wherein supplementing the interaction modes of the target component by using the differential interaction mode set, to obtain the interaction mode set comprises:
in response to the differential interaction mode set comprising the first interaction mode and the at least one defined interaction mode comprising the fourth interaction mode, processing input data using a streaming operation and inputting the processed input data into the fourth interaction mode of the target component, and processing, using the packing operation, data output by the target component through the fourth interaction mode, to obtain the first interaction mode;
in response to the differential interaction mode set comprising the second interaction mode and the at least one defined interaction mode comprising the fourth interaction mode, processing the input data using the streaming operation and inputting the processed input data into the fourth interaction mode of the target component, to obtain the second interaction mode; or
in response to the differential interaction mode set comprising the third interaction mode and the at least one defined interaction mode comprising the fourth interaction mode, processing, using the packing operation, data output by the target component through the fourth interaction mode, to obtain the third interaction mode.

8. The method of claim 4, wherein the packing operation is a packing function that sequentially combines a plurality of first data blocks into second data.

9. The method of claim 4, wherein the streaming operation is a streaming function that sequentially splits a third data block into a plurality of fourth data blocks.

10. The method of claim 2, wherein supplementing the interaction modes of the target component by using the differential interaction mode set, to obtain the interaction mode set comprises:
encapsulating each interaction mode in the differential interaction mode set into the target component.

11. The method of claim 10, wherein encapsulating each interaction mode in the differential interaction mode set into the target component comprises:
setting a target structure according to the at least one defined interaction mode; and
encapsulating the target structure into the target component in response to the target component comprising any of the at least one defined interaction mode.

12. An electronic device, comprising:
at least one processing unit; and
at least one memory, wherein the at least one memory is coupled to the at least one processing unit and stores instructions executable by the at least one processing unit, the instructions, when executed by the at least one processing unit, cause the electronic device to:
determine at least one defined interaction mode of a target component according to a type of a parameter of the target component;
generate an interaction mode set of the target component based on the at least one defined interaction mode, the interaction mode set supporting a plurality of combinations of streaming input, non-streaming input, streaming output and non-streaming output; and
select a target interaction mode of the target component from the interaction mode set based on an operating environment of the target component, to orchestrate the target component.

13. The electronic device of claim 12, wherein the instructions causing the electronic device to generate the interaction mode set of the target component based on the at least one defined interaction mode further cause the electronic device to:
determine a differential interaction mode set for the target component according to the at least one defined interaction mode and an interaction mode set to be generated; and
supplement interaction modes of the target component by using the differential interaction mode set, to obtain the interaction mode set.

14. The electronic device of claim 13, wherein the interaction mode set comprises a plurality of interaction modes of a first interaction mode, a second interaction mode, a third interaction mode, and a fourth interaction mode, the first interaction mode indicates that an input is non-streaming and an output is non-streaming, the second interaction mode indicates that an input is non-streaming and an output is streaming, the third interaction mode indicates that an input is streaming and an output is non-streaming, and the fourth interaction mode indicates that an input is streaming and an output is streaming.

15. The electronic device of claim 14, wherein the instructions causing the electronic device to supplement the interaction modes of the target component by using the differential interaction mode set, to obtain the interaction mode set further cause the electronic device to:
in response to the differential interaction mode set comprising the second interaction mode and the at least one defined interaction mode comprising the first interaction mode, process, using a streaming operation, data output by the target component through the first interaction mode, to obtain the second interaction mode;
in response to the differential interaction mode set comprising the third interaction mode and the at least one defined interaction mode comprising the first interaction mode, process input data using a packing operation and input the processed input data into the first interaction mode of the target component, to obtain the third interaction mode; or
in response to the differential interaction mode set comprising the fourth interaction mode and the at least one defined interaction mode comprising the first interaction mode, process the input data using the packing operation and inputting the processed input data into the first interaction mode of the target component, and process, using the streaming operation, data output by the target component through the first interaction mode, to obtain the fourth interaction mode.

16. The electronic device of claim 14, wherein the instructions causing the electronic device to supplement the interaction modes of the target component by using the differential interaction mode set, to obtain the interaction mode set further cause the electronic device to:
in response to the differential interaction mode set comprising the first interaction mode and the at least one defined interaction mode comprising the second interaction mode, process, using a packing operation, data output by the target component through the second interaction mode, to obtain the first interaction mode;
in response to the differential interaction mode set comprising the third interaction mode and the at least one defined interaction mode comprising the second interaction mode, process input data using the packing operation and input the processed input data into the second interaction mode of the target component, and process, using the packing operation, data output by the target component through the second interaction mode, to obtain the third interaction mode; or
in response to the differential interaction mode set comprising the fourth interaction mode and the at least one defined interaction mode comprising the second interaction mode, process the input data using the packing operation and input the processed input data into the second interaction mode of the target component, to obtain the fourth interaction mode.

17. The electronic device of claim 14, wherein the instructions causing the electronic device to supplement the interaction modes of the target component by using the differential interaction mode set, to obtain the interaction mode set further cause the electronic device to:
in response to the differential interaction mode set comprising the first interaction mode and the at least one defined interaction mode comprising the third interaction mode, process input data using a streaming operation and input the processed input data into the third interaction mode of the target component, to obtain the first interaction mode;
in response to the differential interaction mode set comprising the second interaction mode and the at least one defined interaction mode comprising the third interaction mode, process the input data using the streaming operation and inputting the processed input data into the third interaction mode of the target component, and process, using the streaming operation, data output by the target component through the third interaction mode, to obtain the second interaction mode; or
in response to the differential interaction mode set comprising the fourth interaction mode and the at least one defined interaction mode comprising the third interaction mode, process, using the streaming operation, data output by the target component through the third interaction mode, to obtain the fourth interaction mode.

18. The electronic device of claim 14, wherein the instructions causing the electronic device to supplement the interaction modes of the target component by using the differential interaction mode set, to obtain the interaction mode set further cause the electronic device to:
in response to the differential interaction mode set comprising the first interaction mode and the at least one defined interaction mode comprising the fourth interaction mode, process input data using a streaming operation and input the processed input data into the fourth interaction mode of the target component, and process, using the packing operation, data output by the target component through the fourth interaction mode, to obtain the first interaction mode;
in response to the differential interaction mode set comprising the second interaction mode and the at least one defined interaction mode comprising the fourth interaction mode, process the input data using the streaming operation and input the processed input data into the fourth interaction mode of the target component, to obtain the second interaction mode; or
in response to the differential interaction mode set comprising the third interaction mode and the at least one defined interaction mode comprising the fourth interaction mode, process, using the packing operation, data output by the target component through the fourth interaction mode, to obtain the third interaction mode.

19. The electronic device of claim 15, wherein the packing operation is a packing function that sequentially combines a plurality of first data blocks into second data.

20. A computer program product embodied in a non-transitory computer-readable medium and having a computer program stored thereon, wherein the computer program, when executed by a processor, cause the processor to:
determine at least one defined interaction mode of a target component according to a type of a parameter of the target component;
generate an interaction mode set of the target component based on the at least one defined interaction mode, the interaction mode set supporting a plurality of combinations of streaming input, non-streaming input, streaming output and non-streaming output; and
select a target interaction mode of the target component from the interaction mode set based on an operating environment of the target component, to orchestrate the target component.
